(19) United States
(12) Patent Application Publication
(10) Pub. No.: US 2017/0317557 A1
(43) Pub. Date: Nov. 2, 2017

(54) Controller Integrated Rotating Electrical Machine

(71) Applicant: DENSO CORPORATION, Kariya-city (JP)

(72) Inventors: Hiroshi INAMURA, Kariya-city (JP); Yuki SUZUKI, Kariya-city (JP); Nobuhiro ASANO, Kariya-city (JP); Yuki MAWATARI, Kariya-city (JP); Koji KONDO, Kariya-city (JP)

(73) Assignee: DENSO CORPORATION, Kariya-city (JP)

(21) Appl. No.: 15/499,014

(22) Filed: Apr. 27, 2017

(30) Foreign Application Priority Data
Apr. 29, 2016 (JP) 2016-092171

(51) Int. Cl. H02K 9/06; H02K 11/33; H02K 5/20; H02K 13/10

(52) U.S. Cl. CPC H02K 9/06; H02K 13/10; H02K 11/33; H02K 5/20

(57) ABSTRACT

A controller integrated rotating electrical machine is designed to minimize adverse thermal effects on a control device. The controller device includes switching modules, a control circuit, and a casing. The switching modules are disposed inside the casing at a distance from a rear housing. The control circuit is disposed in the casing and located in front of the switching modules at a distance from the rear housing and the switching modules. In other words, the control circuit is arranged away from the switching modules which are a heat source when operating, thereby eliminating adverse thermal effects on the control circuit.

### CROSS REFERENCE TO RELATED DOCUMENT

The present application claims the benefit of priority of Japanese Patent Application No. 2016-92171 filed on Apr. 29, 2016, the disclosure of which is incorporated herein by reference.

### BACKGROUND

### 1 Technical Field

The invention relates generally to a controller integrated rotating electrical machine equipped with an inverter circuit and a control circuit.

### 2 Background Art

Japanese Patent No. 4123436 assigned to the same assignee as that of this application teaches an inverter integrated AC motor (i.e., a controller integrated rotating electrical machine) which has disposed therein a control device equipped with an inverter circuit and a control circuit.

Specifically, the inverter integrated AC motor includes an AC motor and the control device equipped with the three-phase inverter circuit and the controller. The AC motor, the three-phase inverter circuit, and the controller serve as the rotating electrical machine, the inverter circuit, and the control circuit, respectively.

The three-phase inverter circuit is equipped with six switching devices. The switching devices are secured to a bottom plate Which serves as a heat sink. The controller is also mounted on the bottom plate.

On-off operations of the switching devices are controlled by the controller to supply AC power to the AC motor. The supply of the AC power will be accompanied by flow of a large current through the switching devices. The switching devices, thus, produce heat, so that the temperature thereof will be elevated. The switching devices are, as described above, mounted on the bottom plate, so that the heat, as generated by the switching devices, is dissipated from the bottom plate, thereby minimizing a rise in temperature of the switching devices.

The inverter integrated AC motor, however, faces the drawback in that the controller is also mounted on the bottom plate in addition to the switching devices, thereby causing the heat, as produced by the switching devices, to transfer to the controller through the bottom plate, which may adversely affect an operation of the controller or accelerate aging of electronic devices making up the controller.

### SUMMARY

It is therefore an object to provide a controller integrated rotating electrical machine which is designed to minimize adverse thermal effects on a control circuit.

According to one aspect of the invention, there is provided a controller integrated rotating electrical machine which may be installed in vehicles such as automobiles. The controller integrated rotating electrical machine comprises: (a) a rotating electrical machine which includes an armature winding disposed on a stator, a field winding disposed in a rotor, and a housing which covers axially opposed ends of the stator and the rotor; and (b) a control device which includes a casing, switching modules, a control circuit, and brushes. The casing is secured to an axial rear end of the housing. The switching modules are disposed in the casing at a given distance from the housing and made up of inverter switching devices to deliver electric power to the armature winding. The control circuit is disposed in the casing and located in front of the switching modules in an axial direction of the controller integrated rotating electrical machine at an interval away from the housing and the switching modules. The brushes are disposed in the casing and located at a distance from the housing, the switching modules, and the control circuit. The brushes are at least partially located in front of the switching modules in the axial direction of the controller integrated rotating electrical machine and in back of the control circuit in the axial direction of the controller integrated rotating electrical machine. The brushes work to deliver electrical power to the field winding. In the controller integrated rotating electrical machine, the control circuit is arranged away from the switching modules which will be a heat source when they are in operation, thereby minimizing adverse thermal effects on the control circuit.

In the preferred mode of the disclosure, the brushes are disposed so as to at least partially overlap the switching modules or the control circuit in a radial direction of the controller integrated rotating electrical machine. This enables the rotating electrical machine to have a decreased length.

The brushes may be arranged at a distance from the switching modules and the control circuit in the axial direction of the controller integrated rotating electrical machine. In other words, the brushes may be located in misalignment with the switching modules and the control circuit in the radial direction of the controller integrated rotating electrical machine, thereby minimizing the transmission of heat between the brushes and the switching modules and between the brushes and the control circuit.

The controller integrated rotating electrical machine may further include heat sinks which are placed in contact with the inverter switching devices on an opposite side of the inverter switching devices to the rotating electrical machine to dissipate heat, as generated by the inverter switching devices. The heat, as produced by the inverter switching devices, is transferred to the heat sinks and then dissipated from the heat sinks. The heat sinks are physically or thermally placed in contact with the inverter switching devices on the opposite side of the inverter switching devices to the rotating electrical machine. This minimizes adverse thermal effects on the control circuit.

The brushes may be located in front of rear ends of the heat sinks in the axial direction of the controller integrated rotating electrical machine. This enables the controller integrated rotating machine to have a decreased length.

The controller integrated rotating electrical machine may also include a first cooling flow path and a second cooling flow path. The first cooling flow path delivers a flow of cooling medium to the heat sinks. The second cooling flow path delivers a flow of the cooling medium between the control circuit and the housing. The flow of the cooling medium moving in the first cooling flow path cools the switching modules which have great adverse thermal effects on the control circuit. The flow of the cooling medium moving in the second cooling flow path cools the control circuit. This minimizes the adverse thermal effects on the control circuit.

The first cooling flow path may be designed to direct the cooling medium, as having passed through the heat sinks, into the housing and then discharge the cooling medium outside the housing. This facilitates the ease with which the cooling medium flows in the first cooling flow path and also has the cooling medium pass near the control circuit, thereby cooling the control circuit as well as the switching modules,

The second cooling flow path may also be designed to direct the cooling medium, as having passes between the control circuit and the housing, into the housing, and then discharge it outside the housing. This facilitates the ease with which the cooling medium flows in the second cooling flow path.

The first cooling flow path may be designed to have a flow rate of the cooling medium moving therein which is greater than that moving in the second cooling flow path. This enhances the cooling ability of the controller integrated rotating electrical machine to cool the switching modules and the control circuit.

The first cooling flow path may be designed to have an inlet of the first cooling flow path which is greater in size than that of the second cooling flow path. This establishes the flow rate of the cooling medium moving in the first cooling flow path which is greater than that of the cooling medium moving in the second cooling flow path.

The first cooling flow path may be designed to have an inlet and an outlet which are arranged away from each other in the axial direction of the controller integrated rotating electrical machine. The inlet of the first cooling flow path may be located inside the outlet thereof in the radial direction of the controller integrated rotating electrical machine. This eliminates a risk that the cooling medium, having passed in the first cooling flow path so that it has an increased temperature, flows back into the first cooling flow path again, and thus creates a flow of more low-temperature air into the first cooling flow path.

The controller integrated rotating electrical machine may also include a wall which is arranged between the inlet and the outlet of the first cooling flow path and extends outside the inlet and the outlet of the first cooling flow path in the radial direction of the controller integrated rotating electrical machine. This prevents the cooling medium, having passed in the first cooling flow path so that it has an increased temperature, from flowing back into the first cooling flow path again.

The control device may be equipped with inverter bus bars which are used for the switching modules. The inverter bus bars may be disposed in the first cooling path or have at least a portion partially extending along a flow of the cooling medium moving in the first cooling flow path. This cools the inverter bus bars using the cooling medium passing through the first cooling flow path.

The control device may be equipped with field switching devices which are disposed on a control board on which the control circuit is mounted and controlled by the control circuit to deliver electric power to the field winding. The field switching devices may be placed on or near a surface of the control board which faces the rotating electrical machine. The field switching devices work to deliver the electric power to the field winding, so that they generate heat less heat than the switching modules. The field switching devices are placed on the opposite side of the control board to the switching modules that will be a heat source when operating, thereby thermal interference with the switching modules. This minimizes adverse thermal effects, as arising from the thermal interference between the switching modules and the field switching devices, on the control circuit.

The field switching devices are arranged away from the control board on which the control circuit is mounted and the housing. This minimizes the adverse thermal effects, as arising from the field switching devices, on the control circuit.

The control device is equipped with the three switching modules each of which is made of an assembly or unit of four of the inverter switching devices. The heat sinks are provided one for each of the switching modules. This maximizes the cooling ability of a cooling mechanism including the heat sinks and minimizes a space in the controller integrated rotating electrical machine occupied by the cooling mechanism as compared with the case where the inverter switching devices are arranged to be separate from each other, and the heat sinks are provided one for each of the inverter switching devices. This enables the controller integrated rotating electrical machine to be reduced in size thereof.

The switching modules may be arranged away from each other. Similarly, the heat sinks may be arranged away from each other. The control device may include armature winding bus bars which connect the switching modules to the armature winding. The joints between the armature winding bus bars and the armature winding are each located between every adjacent two of the switching modules and between every adjacent two of the heat sinks. In other words, each of the joints between the armature winding bus bars and the armature winding lies in an empty space between the adjacent switching modules and between the adjacent heat sinks. This eliminates the need for additional spaces used just for the joints of the armature winding bus bars and the armature winding. This avoids an undesirable increase in size of the controller integrated rotating electrical machine.

The joints between the armature winding bus bars and the armature winding may be located closer to the rotating electrical machine than rear ends of the heat sinks are in the axial direction of the controller integrated rotating electrical machine. This enables the controller integrated rotating electrical machine to have a decreased length.

The switching modules and the control circuit may be sealed by resin within the casing. This decreases the thermal resistance therearound to enhance the heat dissipation from the switching modules and the control circuit. This minimizes the adverse thermal effects which arises from the brushes on the control circuit.

In this disclosure, the axial direction represents a direction in which, an axis of the controller integrated rotating electrical machine or the rotating electrical machine extends. The radial direction represents a direction perpendicular to the axial direction.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an axially sectional view of a controller integrated rotating electrical machine according to an embodiment;

FIG. 2 is a side view of the controller integrated rotating electrical machine of FIG. 1;

FIG. 3 is a plan view which illustrates the controller integrated rotating electrical machine of FIG. 1 from which a cover is removed, as viewed from a control device;

FIG. 4 is a side view of a control device installed in the controller integrated rotating electrical machine of FIG. 1 from which a cover is removed;

FIG. 5 is a schematic view which illustrates a body of a casing of the controller integrated rotating electrical machine of FIG. 1 for explaining a locational relation between a brush holder and a control board;

FIG. 6 is a partially enlarged sectional view which illustrates a region around brushes, an inverter circuit, and a control circuit installed in the controller integrated rotating electrical machine of Fig, 1.;

FIG. 7 is a partially enlarged sectional view which illustrates a region around brushes, an inverter circuit, and a control circuit installed in a first modified form of a controller integrated rotating electrical machine;

FIG. 8 is a partially enlarged sectional view which illustrates a region around brushes, an inverter circuit, and a control circuit installed in a second modified form of a controller integrated rotating electrical machine; and

FIG. 9 is a partially enlarged sectional view which illustrates a region around openings of a casing and through-holes of a housing of a third modified form of a controller integrated rotating electrical machine.

### DESCRIPTION OF THE PREFERRED EMBODIMENTS

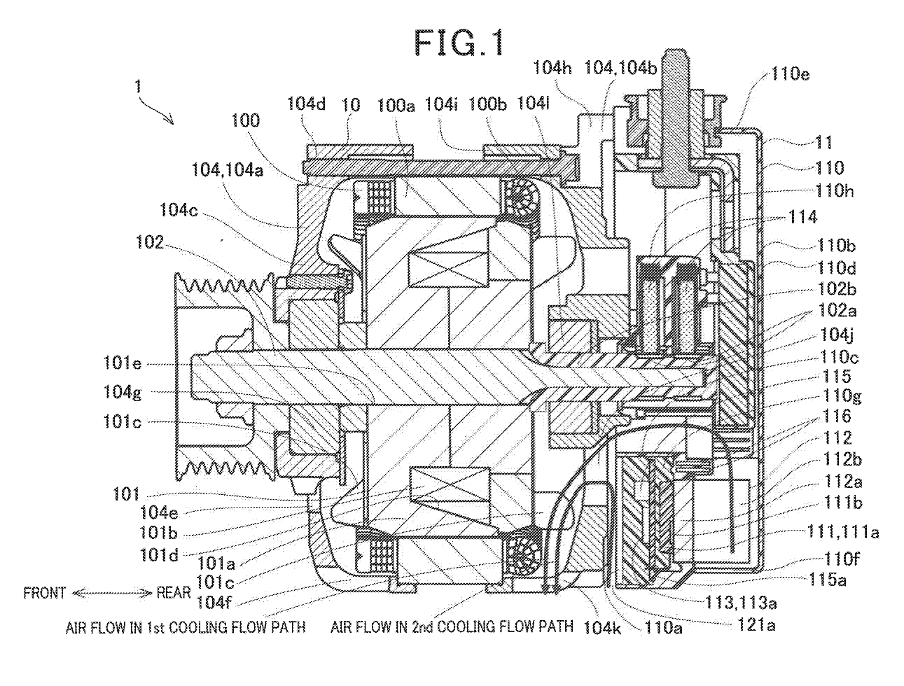

Referring to the drawings, particularly to FIGS. 1 to 5, the controller integrated rotating electrical machine 1 according to an embodiment is shown. The rotating electrical machine 1, as referred to herein, is mounted on a vehicle such as an automobile.

The controller integrated rotating electrical machine 1 shown in FIG. 1 is a device which is supplied with electric power from a storage battery mounted in the vehicle to produce a drive force to move the vehicle and to which a drive force or torque is supplied from an engine such as an internal combustion engine mounted in the vehicle to charge the storage battery. The controller integrated rotating electrical machine 1 is equipped with the rotating electrical machine 10 and the control device 11.

The rotating electrical machine 10 works as a drive force generator which is supplied with electric power to produce drive force to move the vehicle and also works as an electric power generator which is supplied with drive force from the engine to charge the storage battery. The rotating electrical machine 10 is equipped with the stator 100, the rotor 101, the rotating shaft 102, and the housing 104.

The stator 100 constitutes a portion of a magnetic path and is supplied with electric power to generate magnetic flux. Specifically, the stator 100 works as a magnetic flux generator which is supplied with alternating current to generate magnetic flux and also works as an AC generator to produce alternating current through interlinkage with magnetic flux, as generated by the rotor 101. The stator 100 is equipped with the stator core 100a and the armature winding 100b.

The stator core 100a constitutes a portion of the magnetic path and is made of an annular member formed by a magnetic material. The stator core 100a retains the armature winding 100b therein. Although not illustrated, the stator core 100a has a plurality of slots through which the armature winding 100b is wound.

The armature winding 100b is supplied with alternating current to produce magnetic flux and also produce alternating current through interlinkage with magnetic flux, as generated by the rotor 101. The armature winding 100b is made up of two y-connected three-phase windings. The armature winding 100b is retained in the slots of the stator core 100a.

The rotor 101 constitutes a portion of the magnetic path and is supplied with electric power to produce magnetic flux. Specifically, the rotor 101 is supplied with direct current to generate magnetic flux and also produce torque through interlinkage with magnetic flux, as generated by the armature winding 100b. The rotor 101 is also rotated by drive force supplied from the engine mounted in the vehicle to produce magnetic flux which magnetically links with the armature winding 100b, so that the armature winding 100b produces alternating current. The rotor 101 is equipped with the rotor core 101a, the field winding 101b, and the fans 101c.

The rotor core 101a constitutes a portion of the magnetic path and is made of a magnetic material. The rotor core 101a is a so-called Lundell-pole core and retains the field winding 101b therein. The rotor core 101a is equipped with the annular hollow portion 101d in which the field winding 101b is disposed and also has the through-hole 101e through which the rotating shaft 102 passes and which retains the rotating shaft 102 therein.

The field winding 101b is supplied with direct current to produce magnetic flux, thereby creating magnetic poles on an outer periphery of the rotor core 101a. The field winding 101b is disposed and retained in an annular hollow portion of the rotor core 101a.

The fans 101c are mounted on the rotor core 101a and rotated together with the rotor core 101a to suck fresh air from outside the controller integrated rotating electrical machine 1 into the rotating electrical machine 10 and the control device 11. The fans 101c are arranged on a front end surface and a rear end surface of the rotor core 101a, respectively.

The rotor 101 is arranged to have the rotor core 101a whose outer peripheral surface faces an inner peripheral surface of the stator core 100a through a given gap.

The rotating shaft 102 is secured to the rotor 101 and retained by the housing 104 to be rotatable. The rotating shaft 102 is of a cylindrical shape and rotated together with the rotor 101. The rotating shaft 102 passes the through-hole 101e of the rotor 101 and has a central portion of a length thereof retained by the rotor core 101a. The rotating shaft 102 is equipped with the slip rings 102a. An axial direction, as referred to in this discussion, represents a direction in which a rotating axis of the rotating electrical machine 10 extends, in other words, a lengthwise direction of the rotating shaft 102.

The slip rings 102a are made of metallic cylinders which work to supply direct current to the field winding 101b. The slip rings 102a are mounted on an outer peripheral surface of a rear end portion of the rotating shaft 102 through the electric insulator 102b. The slip rings 102a are joined to the electric insulator 102b and connected to the field winding 101b through conductive wires.

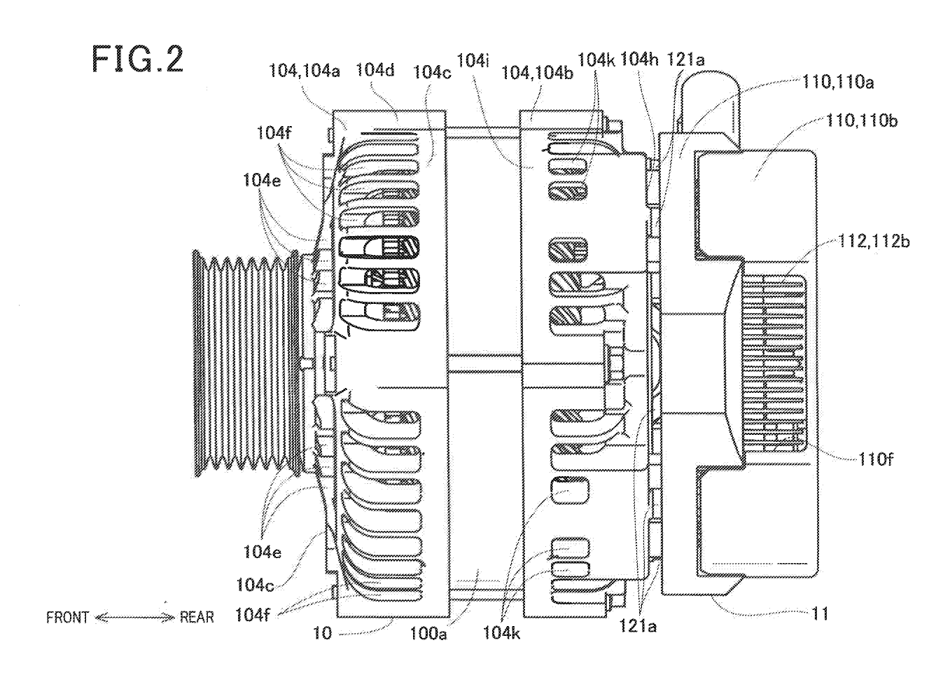

The housing 104, as illustrated in FIGS. 1 and 2, covers axially opposed ends of the stator 100 and axially opposed ends of the rotor 101 and retains the rotating shaft 102 to be rotatable. The control device 11 is secured to the housing 104. The housing 104 is equipped with the front housing 104a and the rear housing 104b.

The front housing 104a covers the front end portions of the stator 100 and the rotor 101 and holds a front side of the rotating shaft 102 to be rotatable. The front housing 104a includes the bottom 104c and the peripheral wall 104d. The bottom 104c has the through-holes 104e formed therein. The peripheral wall 104d has the though-holes 104f formed therein. The front housing 104a has the peripheral wall 104d secured to the front end of the stator core 100a so as to cover the front end portions of the stator 100 and the rotor 101. The front housing 104a retains the front side of the rotating shaft 102 to be rotatable through the bearing 104g with the front end of the rotating shaft 102 protruding frontward outside the front housing 104a.

The rear housing 104b covers the rear end portions of the stator 100 and the rotor 101 and retains the rear side of the rotating shaft 102 to be rotatable. The control device 11 is secured to the rear housing 104b. The rear housing 104h includes the bottom 104h and the peripheral wall 104i. The bottom 104h has at least one through-hole 104j formed therein. Similarly, the peripheral wall 104i has the through-holes 104k formed therein. The rear housing 104b has the peripheral wall 104i secured to the rear end of the stator core 100a so as to cover the rear end portions of the stator 100 and the rotor 101. The rear housing 104b retains the rear side of the rotating shaft 102 to be rotatable through the bearing 1041 with the rear end of the rotating shaft 102 protruding rearward outside the rear housing 104b.

The control device 11 works as a controller to control electric power outputted from the storage battery to the rotating electrical machine 10 to produce the drive force. The control device 11 also works to transform electric power, as produced by the rotating electrical machine 10, to be supplied to the storage battery for charging the storage battery. The control device 11, as illustrated in FIGS. 1, 3, and 4, includes the casing 110, the inverter circuit 111, the field circuit 113, the brushes 114, the control circuit 115, the inverter bus bars 116, and the armature winding bus bars 117.

The casing 110 is, as clearly illustrated in FIGS. 1 and 2, formed by a resinous box and disposed on the rear end of the rear housing 104b to store the inverter circuit 111, the field circuit 113, the brushes 11.4, and the control circuit 115 therein. The casing 110 also serves as a retainer to firmly retain the inverter bus bars 116, the armature winding bus bars 117, and other conductive bus bars. The casing 110 includes the body 110a and the cover 110b.

The body 110a has the inverter circuit 111, the field circuit 113, and the control circuit 115 secured thereto and retains the brushes 114 to be movable in the radial direction thereof. The body 110a, also has the inverter bus bars 116, the armature winding bus bars 117, and other conductive bus bars secured thereto. The body 110a has the through-hole 110c formed in the center thereof. The body 110a is secured to the rear end of the rear housing 104b. The radial direction, as referred to herein, is a direction perpendicular to the rotating axis of the rotating electrical machine 10, in other words, a direction perpendicular to the length of the rotating shaft 102.

The cover 110b covers the rear side of the body 110a. The cover 110b includes the bottom 110d and the peripheral wall 110e. The peripheral wall 110e has a plurality of openings 110f facing the fins 11.2b of the heat sinks 112, respectively, which will be described later in detail.

The inverter circuit 111 shown in FIG. 1 is a circuit working to supply alternating current to the armature winding 100b and also convert alternating current, as outputted from the armature winding 100b to direct current. The inverter circuit 111 is equipped with three switching modules 111a. The inverter circuit 111 is disposed in the casing 110 at a given interval away from the rear housing 104b.

The armature winding 100b is, as described above, made up of the two three-phase windings. The inverter circuit 111, therefore, includes two three-phase inverters. Each of the three-phase inverters is made up of six inverter switching devices 111b. The inverter circuit 111 is, therefore, equipped with the total twelve inverter switching devices 111b.

Each of the switching modules 111a is made up of four of the inverter switching devices 111b which constitute the inverter circuit 111. The switching modules 111a are a heat source excluding conductors such as wires.

The heat sinks 112 are provided one for each of the switching modules 111a. The heat sinks 112 are made of a metallic member and work to dissipate heat, as generated by the inverter switching devices 111b of the switching modules 111a. Each of the heat sinks 112 includes the body (also called a heat sink base) 112a and the fins 112b.

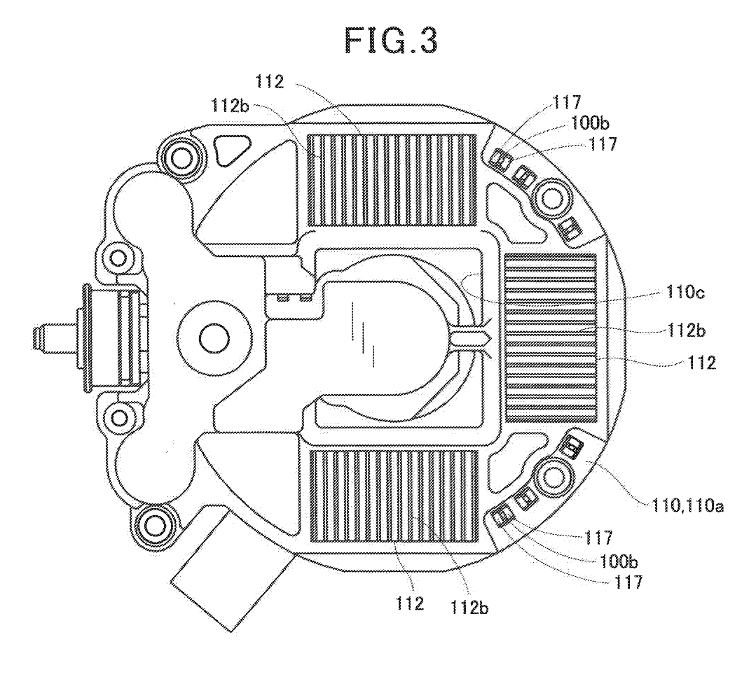

The body 112a is, as can be seen in FIG. 3, made of a rectangular plate. The fins 112b are each made of a thin plate and arranged on a first surface that is one of major surfaces of the body 112a at given intervals away from each other.

The heat sinks 112 are insert-molded in the body 110a of the casing 110 and located away from the rear housing 104b. The body 112a of each of the heat sinks 112 has a second surface that is opposite the first surface thereof on which the fins 112b are mounted. The second surface of the body 112a is exposed to the rotating electrical machine 10. The fins 112b extend away from the rotating electrical machine 10. The switching modules 111a are arranged closer to the rotating electrical machine 10 (i.e., the axial front of the controller integrated rotating electrical machine 1) than the heat sinks 112 are and placed in contact with the heat sinks 112 (i.e., the body 112a). In other words, the heat sinks 112 are on the opposite side of the inverter switching devices 111b to the rotating electrical machine 10 in contact with the inverter switching devices 111b, respectively. Each of the inverter switching devices 111b is practically placed in contact with one of the heat sinks 112 through a thermally conductive adhesive, grease, or sheet, but may be arranged in direct contact with the body 112a of one of the heat sinks 112. The switching modules 111a are, as illustrated in FIGS. 1 and 3, arranged adjacent at a given interval away from each other in the circumferential direction of the rotating electrical machine 10. Similarly, the heat sinks 112 are arranged adjacent at a given interval away from each other in the circumferential direction of the rotating electrical machine 10.

The field circuit 113 shown in FIG. 1 works to supply direct current to the field winding 101b. The field circuit 113 is equipped with field switching devices 113a mounted on the control board 115a on which the control circuit 115, which will be described later in detail, is installed. The field switching devices 113a are placed in contact with the control board 115a. The filed switching devices 113a are a heat source excluding electrical conductors such as lead wires.

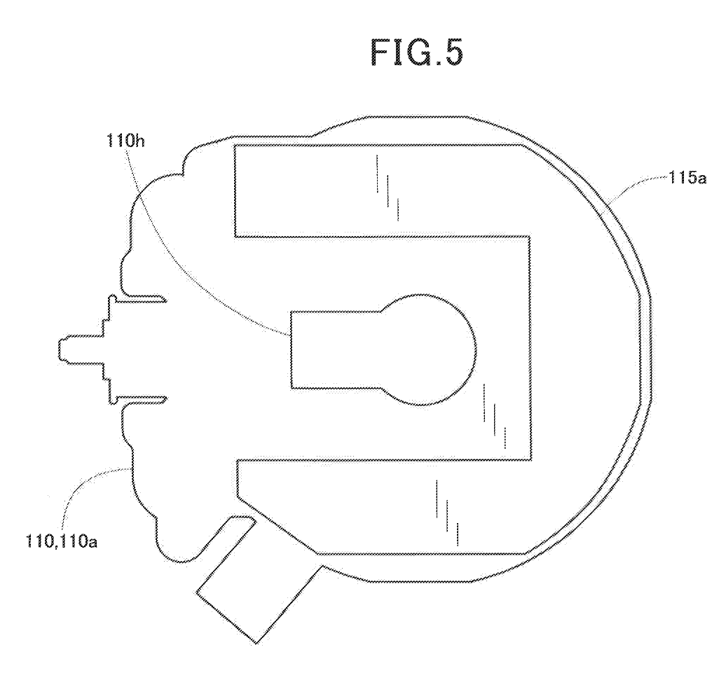

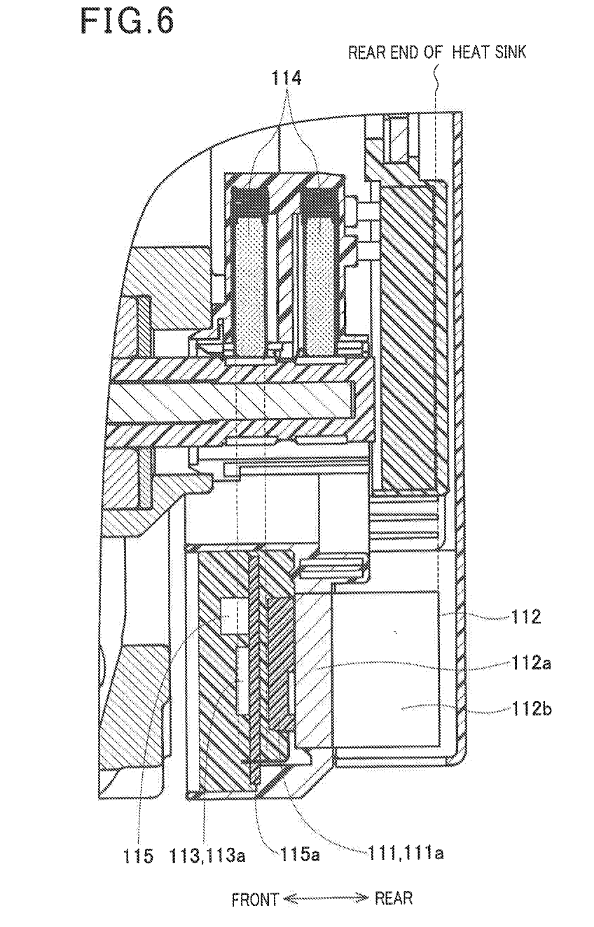

The brushes 114 work to deliver direct current from the field circuit 113 to the field winding 101b through the slip rings 102aThe brushes 114 are disposed in the casing 110. Specifically, the body 110a of the casing 10, as can be seen in FIG. 5, has the brush holder 110h located in the center thereof. The brushes 114 are retained in the brush holder 110h and located away from the rear housing 104b, the inverter circuit 111, and the control circuit 115. The brushes 114 are, as clearly illustrated in FIG. 6, arranged closer to the front of the rotating electrical machine 10 (i.e., the axial front end of the controller integrated rotating electrical machine 1) than the rear ends of the heat sinks 112. Specifically, each of the heat sinks 112 has the front end facing the front of the rotating electrical machine 10 in the axial direction (i.e. the lengthwise direction) of the controller integrated rotating electrical machine 1 and the rear end facing the rear of the rotating electrical machine 1 in the axial direction. The brushes 114 are, as can be seen in FIG. 6, located in front of the rear end of each of the heat sinks 112, as viewed in the axial direction of the controller integrated rotating electrical machine 1. A front one of the brushes 114, as indicated by broken lines in FIG. 6, has at least the rear end or a rear portion located in front of the inverter circuit 111, as viewed in the axial direction of the controller integrated rotating electrical machine 1, and behind the control circuit 115, as viewed in the axial direction of the controller integrated rotating electrical machine 1. The front brush 114 also has a front portion which overlaps the control circuit 115 in the radial direction of the controller integrated rotating electrical machine 1.

The control circuit 115 shown in FIG. 1 works to control operations of the inverter circuit 111 and the field circuit 113. The control circuit 115, as referred to herein, is an electronic component(s) excluding electrical conductors such as lead wires. The control circuit 115 is mounted on the control board 115a which is, as illustrated in FIG. 5, of a U- or C-shape. The control board 115a on which the control circuit 115 is mounted is arranged inside the casing 110 and surrounds the brush holder 110h at a distance from the brush holder 110h. The control board 115a is, as illustrated in FIG. 1, located in front of the inverter circuit 111 in the axial direction of the controller integrated rotating electrical machine 1 at a distance from the rear housing 104b and the inverter circuit 111. The inverter circuit 111 and the control circuit 115 are hermetically sealed by resin 110g within the casing 110.

The inverter bus bars 116 are made of metal and used as electrical conductors for establishing external connections of the inverter circuit 111 (i.e., the switching modules 111a). In practice, the inverter bus bars 116 are implemented by two conductive plates: one of which is connected to the storage battery, and the other is connected to ground. The inverter bus bars 116 are insert-molded in the body 110a of the casing 10 with connecting portions. The inverter bus bars 116 are located inside the fins 112b in the radial direction of the controller integrated rotating electrical machine 1 and at least partially face the fins 112b in the radial direction of the rotating electrical machine 10 within the body 110a of the casing 10.

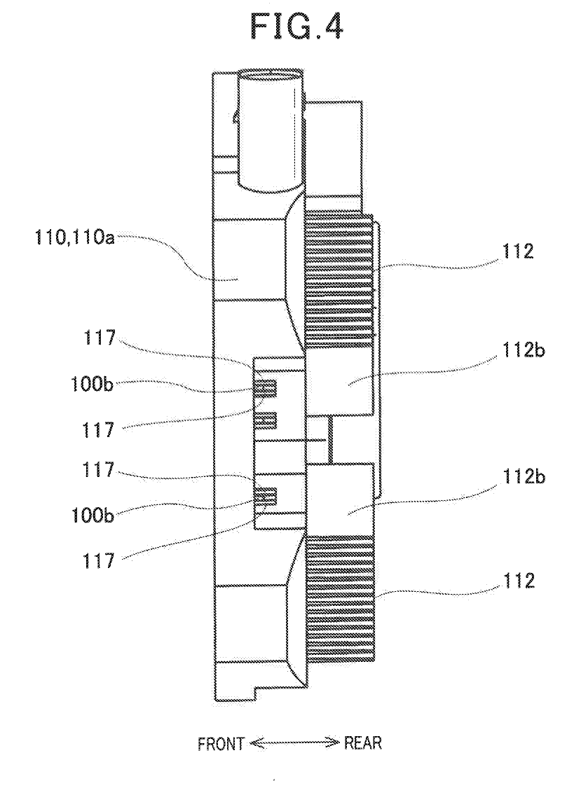

The armature winding bus bars 117 are, as illustrated in FIGS. 3 and 4, made of metallic conductors and connect the switching modules 111a to the armature winding 100b. Jointed ends of the armature winding bus bars 117 and the armature winding 100b are, as can be seen in FIG. 3, each disposed between circumferentially adjacent two of the switching modules 111a and between circumferentially adjacent two of the heat sinks 112 and also located closer to the front of the rotating electrical machine 10 than the rear ends of the heat sinks 112, as viewed in the axial direction of the controller integrated rotating electrical machine 1.

The controller integrated rotating electrical machine 1 is, as illustrated in FIG. 1, equipped with the fans 101c installed on the rotor 101. Rotation of the rotor 101 will cause the fan 101c to create flows of air (i.e., cooling medium) to cool the control device 11.

The controller integrated rotating electrical machine 1 is equipped with the first cooling flow path 120 and the second cooling flow path 121.

The first and second cooling flow paths 120 and 121 are passages through which air flows as a cooling medium. The first and second cooling flow paths 120 and 121 are defined by the casing 110 and the rear housing 104b.

The first cooling flow path 120 delivers a flow of air to the heat sinks 112, directs the flow of air, as having passed through the heat sinks 112, and then discharges the flow of air outside the rear housing 104b. Specifically, the first cooling flow path 120 includes a plurality of flow paths each of which extends from one of the openings 110f of the cover 110b, to the through-hole 110c of the body 110a, to the through-hole 104j in the end surface of the rear housing 104b, and then to the through-holes 104k formed in the outer peripheral surface of the rear housing 104b. In other words, each of the flow paths of the first cooling flow paths 120 delivers a flow of air to a corresponding one of the heat sinks 112, directs the flow of air, as having passed through the one of the heat sinks 112, and then discharges the flow of air outside the rear housing 104b.

The second cooling flow path 121 delivers a flow of air between the control circuit 115 and the rear housing 104b, directs the flow of air, as having passed between the control circuit 115 and the rear housing 104b, into the rear housing 104b, and then discharges the flow of air outside the rear housing 104b. Specifically, the second cooling flow path 121 is a path extending from a plurality of gaps or openings 121a, as can be seen in FIG. 3, formed the casing 110 and the rear housing 104b to the through-hole 104j in the end surface of the rear housing 104b, and then to the through-holes 104k formed in the outer peripheral surface of the rear housing 104b.

The flow rate of air (i.e., cooling medium) moving in the first cooling flow path 120 is greater than that in the second cooling flow path. 121. In other words, an inlet of the first cooling flow path 120 is greater in size than an inlet of the second cooling flow path 121. Specifically, a total transverse area of the openings 110f that are the inlet of the first cooling flow path 120 is selected to be greater than that of the openings 121a that are the inlet of the second cooling flow path 121.

The openings 110f that function as the inlet of the first cooling flow path 120 are arranged away from the through-holes 104k that function as the outlet of the first cooling flow path 120 in the axial direction of the controller integrated rotating electrical machine 1. The openings 110f are located inside the through-holes 104k in the radial direction of the controller integrated rotating electrical machine 1.

The operation of the controller integrated rotating electrical machine 1 will be described below in detail with reference to FIGS. 1, 3, and 4. The controller integrated rotating electrical machine 1 (i.e., the rotating electrical machine 101 is selectively operable in a motor mode and a generator mode. The motor mode will first be discussed.

When an ignition switch of the vehicle is turned on, the direct current is delivered to the switching modules 111a of the inverter circuit 111 through the inverter bus bars 116, as illustrated in FIG. 1. The direct current is also supplied to the field circuit 113 and the control circuit 115 through other conductive bus bars and the control board 115a.

Upon the supply of the direct current, the field circuit 113 and the control circuit 115 start operating. The control circuit 115 is responsive to commands inputted from an external device to control the operations of the inverter circuit 111 and the field circuit 113. The field circuit 113 is controlled by the control circuit 115 to deliver the direct current to the field winding 101b through the brushes 114 and the slip rings 102a. The inverter circuit 111 is controlled by the control circuit 115 to convert the direct current, as inputted through the inverter bus bars 116, into alternating current and supplies it to the armature winding 100b through the armature winding bus bars 117 illustrated in FIGS. 3 and 4. This causes the rotating electrical machine 10 to operate in the motor mode to produce the drive force to move the vehicle.

The inverter switching devices 111b shown in FIG. 1 usually generate heat upon flow of large current therethrough so that the temperature of the inverter switching devices 111b rises. Similarly, the filed switching devices 113a and the brushes 114 also produce heat, so that they have increased temperatures.

Rotation of the rotor 101 will cause the fans 101c to produce flows of air. Specifically, air outside the controller integrated rotating electrical machine 1 is sucked into the cover 110b through the openings 110f and moved from the through-hole 110c of the body 110a into the rear housing 104b through the through-hole 104j formed in the end surface of the rear housing 104b, and then discharged from the through-holes 104k formed in the outer periphery of the rear housing 104b. Additionally, air outside the controller integrated rotating electrical machine 1 is also sucked into the openings 121a between the casing 110 and the rear housing 104b and moved into the rear housing 104b through the through-hole 104j, and then discharged from the through-holes 104k formed in the outer periphery of the rear housing 104b. This cools the control device 11.

Next, the generator mode of the controller integrated rotating electrical machine 1 to charge the storage battery mounted in the vehicle will be described below.

When the generator mode is entered, the rotating electrical machine is supplied with the drive power from the engine mounted in the vehicle, so that the armature winding 100b generates alternating current. The control circuit 115 stops switching the inverter switching devices 111b of the switching modules 111a. Diodes installed in the inverter switching devices 111b work to convert the alternating current, as delivered from the armature winding 100b through the armature winding bus bars 117 illustrated in FIGS. 3 and 4, into direct current and then outputs it to the storage battery mounted in the vehicle. The storage battery is, thus, charged by the electric power generated by the rotating electrical machine 10.

The control circuit 115 may be designed to turn on or off the inverter switching devices 111b of the switching modules 111a as a function of an angle of rotation of the rotor 101 to convert three-phase alternating current, as produced by the armature winding 100b, into direct current.

In the generator mode, the direct current is delivered from the field circuit 113 shown in FIG. 1 to the field winding 101b through the brushes 114. This causes the field switching devices 113a and the brushes 114 to generate heat, so that the temperature thereof will rise. Like in the motor mode, the above described cooling mechanism of the controller integrated rotating electrical machine 1 serves to cool the control device 11.

The beneficial advantages, as offered by the controller integrated rotating electrical machine 1 of this embodiment will be described below.

The control device 11 is, as already described, equipped with the switching modules 111a and the control circuit 115. The switching modules 111a are disposed in the casing 110 at a given distance away from the rear housing 104b. The control circuit 115 is mounted in the casing 110 and, as clearly illustrated in FIG. 1, located in front of the switching modules 111a, as viewed in the axial direction of the controller integrated rotating electrical machine 1, at an interval away from the rear housing 104b and the switching modules 111a. In other words, the control circuit 115 is arranged at a distance from the switching modules 111a that are a heat source, thereby minimizing adverse thermal effects on the control circuit 115.

One of the brushes 114 which is located closer to the front of the rotating electrical machine 1 than the other, as described above, overlaps with the control circuit 15 in the radial direction of the controller integrated rotating electrical machine 1, thereby resulting in a decreased length of the rotating electrical machine 10.

The heat, as produced by the inverter switching devices 111b, is transferred to the heat sinks 112 and then dissipated from the heat sinks 112. The heat sinks 112 are physically or thermally placed in contact with the inverter switching devices 111b on the opposite side of the inverter switching devices 111b to the rotating electrical machine 10. In other words, each of the heat sinks 112 contacts one of opposed surfaces of the inverter switching device 111b which is farther away from the control circuit 115. The control circuit 115 is on the opposite side of the inverter switching devices 111b to the heat sinks 112, that is, mounted on one of opposed major surfaces (which will also be referred to as a first and a second surface) of the circuit board 115a which is farther away from the inverter switching devices 111b and the heat sinks 112. The circuit board 15 is located away from a thermal path through which the heat, as generated by the inverter switching devices 11b, is transferred to the heat sinks 112. This minimizes the adverse thermal effects on the operation of the control circuit 115.

The brushes 114 are used to deliver the electric power to the field winding 101b, so that the brushes 114 generate less heat than the switching modules 111a. The brushes 114 are located closer to the front of the rotating electrical machine 10 than the rear ends of the heat sinks 112 are, thereby resulting in a decreased length of the controller integrated rotating electrical machine 1.

The controller integrated rotating electrical machine 1 is, as described above, equipped with the first cooling flow path 120 and the second cooling flow path 121. The first cooling flow path 120 serves to create a flow of air passing through the heat sinks 112. The second cooling flow path 121 serves to create a flow of air passing between the control circuit 115 and the rear housing 104b. The flow of air moving in the first cooling flow path 120 cools the switching modules 111a which have great adverse thermal effects on the control circuit 115. The flow of air moving in the second cooling flow path 121 cools the control circuit 115. This minimizes the adverse thermal effects on the control circuit 115.

The first cooling flow path 120 is designed to direct the flow of air, having passed through the heat sinks 112, outside the rear housing 104b through the rear housing 104b, thereby facilitating the ease with which the air flows in the first cooling flow path 120. The air in the first cooling flow path 120 passes near the control circuit 115, thereby cooling the control circuit 115 as well as the switching modules 111a.

The second cooling flow path 121 is also designed direct the air, having passed between the control circuit 115 and the rear housing 104b, into the rear housing 104b, and then discharge it outside the rear housing 104b, thereby facilitating the ease with which the air flows in the second cooling flow path 121.

The flow rate of air moving in the first cooling flow path 120 is, as described above, greater than that in the second cooling flow path 121. This enhances the ability of the cooling mechanism to cool the switching modules 111a and the control circuit 115.

The size of the inlet of the first cooling flow path 120 is, as described above, greater than that of the second cooling flow path 121. Specifically, a total transverse area of the openings 110f that are the inlet of the first cooling flow path 120 is selected to be greater than that of the openings 121a that are the inlet of the second cooling flow path 121, thereby establishing the flow rate of air moving in the first cooling flow path 120 which is greater than that of air moving in the second cooling flow path 121.

The openings 110f that function as the inlet of the first cooling flow path 120 are arranged away from the through-holes 104k that function as the outlet of the first cooling flow path 120 in the axial direction of the controller integrated rotating electrical machine 1. The openings 110f are located inside the through-holes 104k in the radial direction of the controller integrated rotating electrical machine 1. This eliminates a risk that the air (i.e., a cooling medium), as having passed in the first cooling flow path 120 so that it has an increased temperature, flows back into the first cooling flow path 120 again, and thus creates a flow of more low-temperature air into the first cooling flow path 120.

The control device 11 is equipped with the inverter bus bars 116. The inverter bus bars 116 are, as can be seen in FIG. 1, arranged in the first cooling flow path 120, so that the inverter bus bars 116 are cooled by the air passing through the first cooling flow path 120.

The field switching devices 113a work to deliver the electric power to the field winding 101b, so that they generate less heat than the switching modules 111a. The field switching devices 113a are placed on the major surface of the control board 115a on which the control circuit 115 is mounted and which faces the rotating electrical machine 1, thereby avoiding thermal interference with the switching modules 111a. This minimizes adverse thermal effects, as arising from the thermal interference between the switching modules 111a and the field switching devices 113a, on the control circuit 115.

The control device 11 is equipped with the three switching modules 111a. Each of the switching modules 111a is made of an assembly of the four inverter switching devices 111b connected as a unit. The heat sinks 112 are provided one for each of the switching modules 111a. This maximizes the cooling ability of the cooling mechanism including the heat sinks 112 and minimizes a space in the controller integrated rotating electrical machine 1 occupied by the cooling mechanism as compared with the case where the inverter switching devices 111b are arranged to be separate from each other, and the heat sinks 112 are provided one for each of the inverter switching devices 111b, This enables the controller integrated rotating electrical machine 1 to be reduced in size thereof.

The control device 11 is equipped with the armature winding bus bars 117. The armature winding bus bars 117 are electrical conductors to electrically connect the switching modules 111a to the armature winding 100b. The switching modules 111a are arranged at a given interval away from each other in the circumferential direction of the control device 11 (i.e., the controller integrated rotating electrical machine 1). Similarly, the heat sinks 112 are arranged at a given interval away from each other in the circumferential direction of the control device 11 (i.e., the controller integrated rotating electrical machine 1). The joints between the armature winding bus bars 117 and portions of the armature winding 100b are, as can be seen in FIG. 3, each located between every adjacent two of the switching modules 111a and between every adjacent two of the heat sinks 112. In other words, each of the joints between the armature winding bus bars 117 and the armature winding 100b lies in an empty space between the adjacent switching modules 111a and between the adjacent heat sinks 112. This eliminates the need for additional spaces used just for the joints of the armature winding bus bars 117 and the armature winding 100b. This avoids an undesirable increase in size of the controller integrated rotating electrical machine 1.

The joints between the armature winding bus bars 117 and the armature winding 100b are located closer to the rotating electrical machine 10 than the rear ends of the heat sinks 112 are in the axial direction of the controller integrated rotating electrical machine 1, thereby resulting in a decreased length of the controller integrated rotating electrical machine 1.

The switching modules 111a and the control circuit 115 are hermetically sealed by the resin 110g within the casing 110, thereby decreasing the thermal resistance therearound to enhance the heat dissipation from the switching modules 111a and the control circuit 115.

The above discussion refers to the example where a front one of the brushes 114 has at least a rear end or a rear portion located in front of the switching modules 111a, as viewed in the axial direction of the controller integrated rotating electrical machine 1, and behind the control circuit 115, as viewed in the axial direction of the controller integrated rotating electrical machine 1, but however, the structure of the controller integrated rotating electrical machine 1 may be modified. For instance, the brushes 114 may be at least partially located in front of the switching modules 111a, as viewed in the axial direction of the controller integrated rotating electrical machine 1, and in the rear of the control circuit 115, as viewed in the axial direction of the controller integrated rotating electrical machine 1. In other words, the brushes 114 may be at least partially arranged closer to the front of the controller integrated rotating electrical machine 1 than the switching modules 11a and also closer to the rear of the controller integrated rotating electrical machine 1 than the control circuit 115 in the axial direction of the controller integrated rotating electrical machine 1.

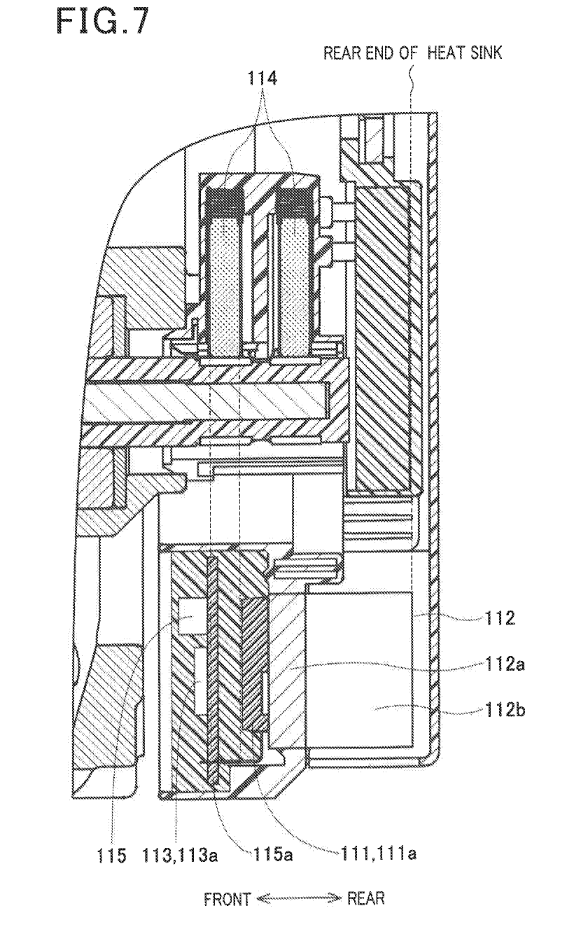

The front brush 114, as described already, has a front portion which overlaps the control circuit 115 in the radial direction of the controller integrated rotating electrical machine 1, but however, the brushes 114 may be arranged to at least partially overlap the switching modules 111a or the control circuit 115 in the radial direction of the controller integrated rotating electrical machine 1. Alternatively, the brushes 114 may be, as indicated by broken lines in FIG. 7, arranged away from the switching modules 111a, and the control circuit 115 in the axial direction of the controller integrated rotating electrical machine 1, that is, not overlap the switching modules 111a and the control circuit 115 in the radial direction of the controller integrated rotating electrical machine 1. This arrangement minimizes the transmission of heat between the brushes 114 and the switching modules 111a and between the brushes 114 and the control circuit 115.

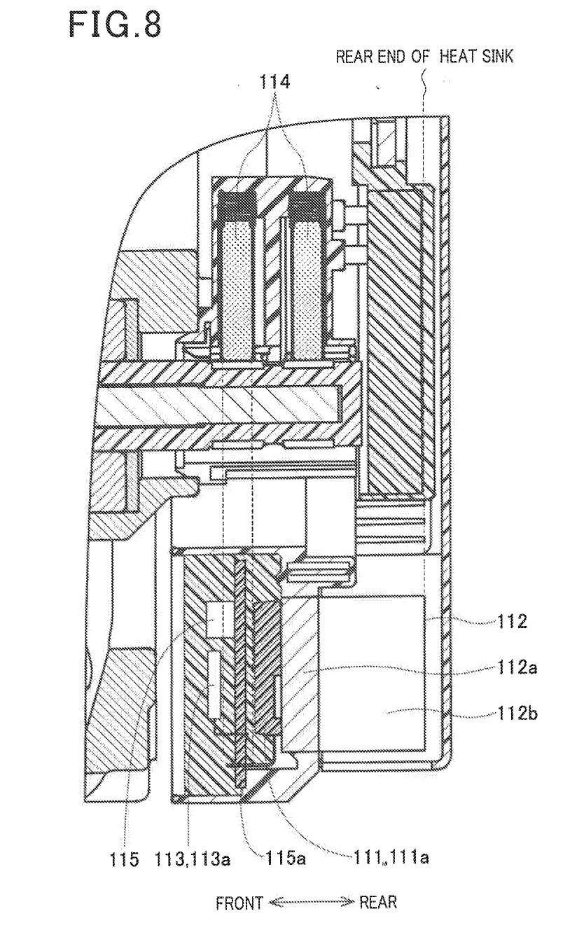

The above discussion refers to the example where the body of each of the field switching devices 113a is placed in contact with the surface of the control board 11.5a, but however, the controller integrated rotating electrical machine 1 may alternatively be designed to have another structure. For instance, each of the field switching devices 113a may, as illustrated in FIG. 8, have the body located at a given distance away from the surface of the control board 115a and the inner surface of the housing 104. This minimizes adverse effects of heat, as generated by the field switching devices 1 la, on the control circuit 115.

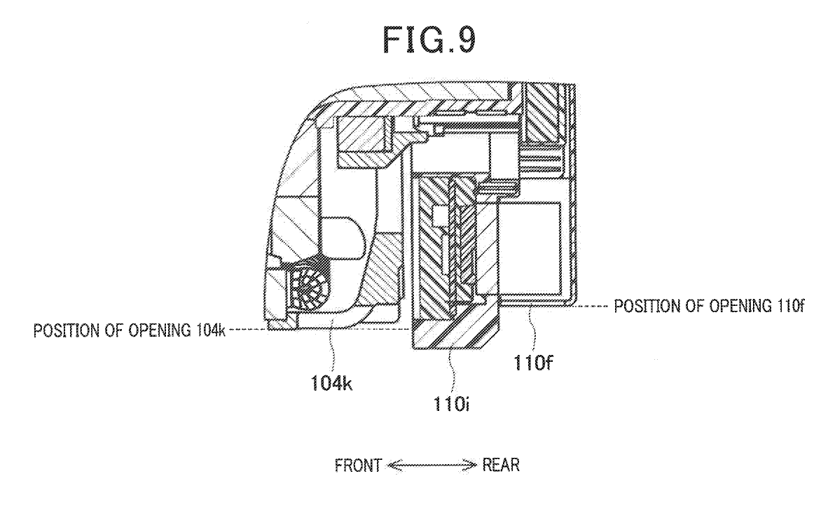

The above discussion refers to the example where the openings 110f are, as clearly illustrated in FIGS. 1 and 2, arranged inside the through-holes 104k in the radial direction of the controller integrated rotating electrical machine 1, but however, the controller integrated rotating electrical machine 1 may alternatively be designed to have another structure. For instance, the control device 11 (i.e., the casing 110) may as illustrated in FIG. 9, be shaped to have the wall 110i arranged between the openings 110f and the through-holes 104k. The wall 110i extends, as clearly indicated by broken lines in FIG. 9, outside the openings 110f and the through-holes 104k in the radial direction of the controller integrated rotating electrical machine 1. The wall 110i functions to stop the air, as having passed through the first cooling flow path 120 so that the temperature of the air has an increased temperature, from flowing back into the first cooling flow path 120 again.

The above discussion refers to the example where the inverter bus bars 116 are installed inside the first cooling flow path 120, but however, the inverter bus bars 116 may alternatively be arranged to at least have a portion which partially extends along or parallel to a flow of air moving in the first cooling flow path 120, that is, a length of the first cooling flow path 120. This also offers the beneficial advantages that the inverter bus bars 116 are cooled by the air flowing through the first cooling flow path 120.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

What is claimed is:

1. A controller integrated rotating electrical machine comprising:
a rotating electrical machine which includes an armature winding disposed on a stator, a field winding disposed in a rotor, and a housing which covers axially opposed ends of the stator and the rotor; and
a control device which includes a casing, switching modules, a control circuit, and brushes, the casing being secured to an axial rear end of the housing, the switching modules being disposed in the casing at a given distance from the housing and made up of inverter switching devices to deliver electric power to the armature winding, the control circuit being disposed in the casing and located in front of the switching modules in an axial direction of the controller integrated rotating electrical machine at an interval away from the housing and the switching modules, the brushes being disposed in the casing and located at a distance from the housing, the switching modules, and the control circuit, the brushes being at least partially located in front of the switching modules in the axial direction of the controller integrated rotating electrical machine and behind the control circuit in the axial direction of the controller integrated rotating electrical machine, the brushes working to deliver electrical power to the field winding.

2. A controller integrated rotating electrical machine as set forth in claim 1, wherein the brushes at least partially overlap the switching modules or the control circuit in a radial direction of the controller integrated rotating electrical machine.

3. A controller integrated rotating electrical machine as set forth in claim 1, wherein the brushes are arranged at a distance from the switching modules and the control circuit in the axial direction of the controller integrated rotating electrical machine.

4. A controller integrated rotating electrical machine as set forth in claim 1, further comprising heat sinks which are placed in contact with the inverter switching devices on an opposite side of the inverter switching devices to the rotating electrical machine to dissipate heat, as generated by the inverter switching devices.

5. A controller integrated rotating electrical machine as set forth in claim 4, wherein the brushes are located in front of rear ends of the heat sinks in the axial direction of the controller integrated rotating electrical machine.

6. A controller integrated rotating electrical machine as set forth in claim 1, further comprising a first cooling flow path and a second cooling flow path, the first cooling flow path delivering a flow of cooling medium to the heat sinks, the second cooling flow path delivering a flow of the cooling medium between the control circuit and the housing.

7. A controller integrated rotating electrical machine as set forth in claim 6, wherein the first cooling flow path serves to direct the cooling medium, as having passed through the heat sinks, into the housing and then discharge the cooling medium outside the housing.

8. A controller integrated rotating electrical machine as set forth in claim 6, wherein the second cooling flow path serves to direct the cooling medium, as having passed between the control circuit and the housing, into the housing, and then discharge the cooling medium outside the housing.

9. A controller integrated rotating electrical machine as set forth in claim 6, wherein a flow rate of the cooling medium moving in the first cooling flow path is greater than that in the second cooling flow path.

10. A controller integrated rotating electrical machine as set forth in claim 9, wherein an inlet of the first cooling flow path is greater in size than that of the second cooling flow path.

11. A controller integrated rotating electrical machine as set forth in claim 6, wherein the first cooling flow path has an inlet and an outlet which are arranged away from each other in the axial direction of the controller integrated rotating electrical machine, and wherein the inlet of the first cooling flow path is located inside the outlet thereof in a radial direction of the controller integrated rotating electrical machine.

12. A controller integrated rotating electrical machine as set forth in claim 6, wherein the first cooling flow path has an inlet and an outlet which are arranged away from each other in the axial direction of the controller integrated rotating electrical machine, and wherein the casing has a wall which is arranged between the inlet and the outlet of the first cooling flow path and extends outside the inlet and the outlet of the first cooling flow path in the radial direction of the controller integrated rotating electrical machine.

13. A controller integrated rotating electrical machine as set forth in claim 6, wherein the control device is equipped with inverter bus bars which are used for the switching modules, the inverter bus bars being disposed in the first cooling path or having at least has a portion partially extending along a flow of the cooling medium moving in the first cooling flow path.

14. A controller integrated rotating electrical machine as set forth in claim 1, wherein the control device is equipped with field switching devices which are disposed on a control board on which the control circuit is mounted and controlled by the control circuit to deliver electric power to the field winding, the field switching devices being placed on a surface of the control board which faces the rotating electrical machine.

15. A controller integrated rotating electrical machine as set forth in claim 1, wherein the control device is equipped with field switching devices which are controlled by the control circuit to deliver electric power to the field winding, the field switching devices being arranged away from a control board on which the control circuit is mounted and the housing.

16. A controller integrated rotating electrical machine as set forth in claim 1, wherein the control device is equipped with the three switching modules each of which is made of a unit of four of the inverter switching devices, and wherein the heat sinks are provided one for each of the switching modules.

17. A controller integrated rotating electrical machine as set forth in claim 16, wherein the switching modules are arranged away from each other, and the heat sinks are arranged away from each other, wherein the control device includes armature winding bus bars which connect the switching modules to the armature winding, and wherein joints between the armature winding bus bars and the armature winding are each located between every adjacent two of the switching modules and between every adjacent two of the heat sinks.

18. A controller integrated rotating electrical machine as set forth in claim 17, wherein the joints between the armature winding bus bars and the armature winding are located closer to the rotating electrical machine than rear ends of the heat sinks are in the axial direction of the controller integrated rotating electrical machine.

19. A controller integrated rotating electrical machine as set forth in claim 1, wherein the switching modules and the control circuit are sealed by resin within the casing.

20. A controller integrated rotating electrical machine as set forth in claim 14, wherein the brushes are retained in a brush holder disposed in the casing, and wherein the control board is located at a distance from the brush holder.

21. A controller integrated rotating electrical machine as set forth in claim 15, wherein the brushes are retained in a brush holder disposed in the casing, and wherein the control board is located at a distance from the brush holder.

22. A controller integrated rotating electrical machine as set forth in claim 6, wherein the first cooling flow path includes a plurality of flow paths each of which delivers a flow of the cooling medium to one of the heat sinks.

23. A controller integrated rotating electrical machine as set forth in claim 22, wherein each of the flow paths of the first cooling flow path serves to direct the cooling medium, as having passed through one of the heat sinks, into the housing and then discharge the cooling medium outside the housing.
